(19) United States
(12) Patent Application Publication
(10) Pub. No.: US 2006/0052559 A1
(43) Pub. Date: Mar. 9, 2006

(54) Insoluble, highly cross-linked popcorn polymers containing styrene-4-sulfonate methods for the production and use thereof

(75) Inventors: Marcos Gomez, Heidelberg (DE); Frank Dietsche, Schriesheim (DE)

Correspondence Address: CONNOLLY BOVE LODGE & HUTZ, LLP, P O BOX 2207, WILMINGTON, DE, 19899, US

(73) Assignee: BASF AKTIENGESELLSCHAFT, Ludwigshafen (DE)

(21) Appl. No.: 10/537,506

(22) PCT Filed: Nov. 28, 2003
(86) PCT No.: PCT/EP03/13465

§ 371 Date: Jun. 3, 2005

(30) Foreign Application Priority Data
Dec. 5, 2002 (DE) 102 57 095.7

(51) Int. Cl. C08F 26/10

(52) U.S. Cl. 526/264

(57) ABSTRACT

The invention relates to insoluble, highly crosslinked, slightly swellable styrene-4-sulfonate-containing popcorn polymers, a process for preparation thereof and use thereof as adsorbents, ion exchangers, support materials, filter aids, dye transfer inhibitors for laundry detergents or additives in cosmetic, dermatological or pharmaceutical formulations, as tablet disintegrants. In particular, the styrene-4-sulfonate-containing popcorn polymers are to be used for filtering liquids, in particular beer, and also as tablet disintegrants.

The invention relates to insoluble, highly crosslinked, slightly swellable styrene-4-sulfonate-containing popcorn polymers, a process for preparation thereof and use thereof as adsorbents, ion exchangers, support materials, filter aids, dye transfer inhibitors for laundry detergents or additives in cosmetic, dermatological or pharmaceutical formulations, as tablet disintegrants. In particular, the styrene-4-sulfonate-containing popcorn polymers are to be used for filtering liquids, in particular beer, and as tablet disintegrants.

The name popcorn polymers is used for foamy, crusty polymer grains having a cauliflower-like structure. On account of their generally high degree of crosslinking, popcorn polymers are generally insoluble and scarcely swellable.

Popcorn polymers are used, for example, for adsorbing tannins from beverages and as ion exchangers. Carboxyl-containing popcorn polymers can be obtained, for example, by saponifying polymers containing acrylic ester and acrylamide units.

Ullmanns Enzyklopädia der Tech. Chemie [Ullmann's Encyclopedia of Industrial Chemistry], 4th edition, volume 19, page 385 (1980) discloses that when N-vinylpyrrolidone is heated with hydroxides and alkoxides of alkali metals and alkaline earth metals, in a spontaneous reaction, an insoluble, slightly water-swellable polymer is formed. Such substances which are termed popcorn polymers are also produced when N-vinylpyrrolidone is heated with divinyl compounds in the absence of oxygen.

The separation of solid-liquid mixtures via filtration is an important process step in many industrial production processes. The term filter aid is taken to mean a number of products which are used in bulk, powdered, granulated or fibrous form as precoat material in filtration.

Filter aids can be applied to the filter medium before filtration is started as a filter aid layer (precoat filter), or, to achieve a looser cake structure, can be added continuously to the mixture/solution to be filtered.

The most important filter additives used are:
Diatoms, natural products which originate from calcining diatomite. The main constituents are amorphous SiO₂ modifications accompanied by aluminum oxides and iron oxides and other elements, and their silicate compounds.
Perlites, these are ignited, ground, selected, expanded clays of volcanic origin (rhyolite). Their structure is sheet-like and may be described chemically as a sodium, potassium or aluminum silicate.
Bentonites are clay minerals having high swelling and adsorption capacity.
Celluloses, organic renewable raw materials (cellulose, wood pulp, etc.). The use of these mainly fibrous products offers advantages for consumers. Owing to the fibrous structure, relatively high throughputs are achieved. In addition, these are soft, non-abrasive materials.
Synthetic materials, such as polymeric crosslinked particles.

During the filtration these additives form a porous environment which absorbs the impurities to be eliminated and facilitates the outflow of the liquid phase.

The additives should have increased porosity. The porous environment, in addition, should not deform under the influence of pressure. Furthermore, an additive should be chemically inert and should also be recoverable, with the used cakes of additives frequently comprising a highly contaminated mixture. This is the case especially with brewing.

For filtering beer, predominantly kieselguhr precoat filters and sheet filters are currently used. In the case of precoat filtration, before the start of filtration, a preliminary kieselguhr layer is precoated onto a support surface (filter mesh). After precoating with this preliminary layer, a mixture of fine and coarse kieselguhr is added to the unfiltered beer. During beer production a kieselguhr consumption of from 150 to 200 g/hl of beer must be expected. Kieselguhr is particularly proven for precoat filtration because of its high pore volume, low bulk density, relatively high absorption capacity and high specific surface area.

If the efficiency of kieselguhr is spent after a number of filter operating hours due to retained solid material including yeasts and bacteria, the kieselguhr is removed from the support surfaces of the filter.

However, owing to legal regulations, landfilling this spent kieselguhr is possible only with difficulty and expense. Attempts to regenerate the kieselguhr which has become unusable as filter material, that is to say freeing it from adhering solid particles for reuse as filter material, have not proven possible to carry out in practice. The only successful technique has been an ignition treatment carried out for regeneration purposes. After such an ignition treatment, however, the kieselguhr was found to be markedly changed compared with its original state. In particular, the ignition treatment led to a drastic reduction in specific surface area, and thus of the pore volume.

In addition, kieselguhr has been under discussion for some time because of possible carcinogenic activity. In the USA it has already been classified as carcinogenic. Furthermore, disposal of the filter cakes poses difficulties for the abovementioned reason. Potentially, protective measures will become necessary for handling kieselguhr, which will give rise to high capital expenditure.

DE 19929944 describes insoluble styrene-3-sulfone-containing crosslinked polymers, processes for production thereof and the use of the crosslinked polymers as adsorbents, ion exchangers, support materials and filter aids.

WO 98/40149 describes the use of finely divided particles of plant fibers as filter aid. These filter aids comprise wood particles, wood fibers and wood comminution residues. These filter aids have been subjected to treatment with a dilute acid and/or alkali solution.

EP 351363 relates to the use of highly crosslinked polyvinylpyrrolidone (PVP) having a particle size of from 1 μm to 300 μm as stabilizers and simultaneously filter aids of a liquid medium, in particular beer, wine or fruit juice.

WO 96/35497 describes novel regenerable filter aids for filtering a liquid medium, in particular beer, which comprise grains of synthetic or natural incompressible polymers. These polymeric grains are composed of polyamide, polyvinyl chloride, polypropylene, polystyrenes, polycaprolactams, inter alia.

EP 483 099 describes the beer filtration process where filter aids are used which are spherical particles having a particle size distribution from 5 to 50 μm. These filter aids should be incompressible, resistant to wear, regenerable and not very temperature-sensitive.

There is, however, an need for alternative filter aids, particularly for applications in beer filtration. Wood particles and fibers are not chemically inert. Synthetic polymers such as highly crosslinked polyvinylpyrrolidone are very effective binders for binding polyphenols, for example, but this action is not wanted in beer filtration, because a reduction in polyphenols also impairs the flavor.

It is an object of the present invention to develop an insoluble and only slightly swellable polymer which is chemically inert and of a pure surface, and in addition has a large surface area and also can be produced simply and in acceptable reaction times. The polymer should serve, as a regenerable filter aid, to remove fine and compressible particles, especially to remove beer yeasts, which lead to plugging of the pores of filter aids or filter cakes.

In addition, it is an object of the present invention to provide novel substances which can be used as adsorbents, ion exchangers, support materials, filter aids, dye transfer inhibitors for laundry detergents, or additives in cosmetic, dermatological or pharmaceutical formulations.

We have found that this object is achieved according to the invention using insoluble only slightly swellable popcorn polymers comprising

a) from 20 to 100% by weight of styrene-4-sulfonate and/or a styrene-4-sulfonate-containing derivative of the formula (I) 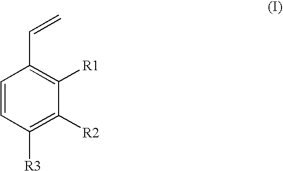
where
R₁, R₂ can be identical or different and are chlorine, bromine, iodine or C₁-C₄-alkyl and
R₃ SO₃⁻— or SO₃H

b) from 0 to 40% by weight of an N-vinyllactam or N-vinylamine,

c) from 0 to 10% by weight of at least one bifunctional crosslinker component

d) from 0 to 80% by weight of further free-radically polyrnerizable monomers

where the percentages by weight of the individual components a) to d) relate to the total amount of the popcorn polymer and total 100%.

Surprisingly, it has now been found that insoluble, highly crosslinked, slightly swellable styrene-4-sulfonate-containing polymers having high surface areas can be used for the desired applications. The sedimentation behavior and the filtration action of these styrene-4-sulfonate-containing polymers are extremely effective compared with nonpolar styrene-containing popcorn polymers.

For the purposes of the present invention, monomers a) are the alkaline earth or alkali metal salts of styrene-4-sulfonates, either neutralized or not neutralized, and also isomers of styrene-4-sulfonic acid, for example styrene-3-sulfonic acid or sodium styrene-3-sulfonate, and also alkaline earth or alkali metal salts thereof. Preference as monomer a) is given to styrene-4-sulfonic acid, and preference is given in particular to sodium styrene-4-sulfonate.

The monomers a) are used in the context of the invention in amounts of from 20 to 100% by weight, preferably from 50 to 100% by weight, particularly preferably from 70 to 100% by weight, based on the total amount of the polymer.

The hydrophilic component b) generally means N-vinyllactams or N-vinylamines, for example the following polymerizable comonomers are mentioned: N-vinyllactams and N-vinylamines, in particular N-vinylpyrrolidone, N-vinylpiperidone, N-vinylcaprolactam, N-vinylimidazole, N-vinyl-2-methylimidazole, N-vinyl4-methylimidazole and N-vinylformamide.

Preferred hydrophilic components are N-vinylpyrrolidone, N-vinylimidazole and N-vinyl-caprolactam, and particular preference is given to N-vinylpyrrolidone.

The monomers b) are used in the context of the invention in amounts of from 0 to 40% by weight, preferably from 0.5 to 30% by weight, and particular preferably in amounts of from 1 to 25% by weight, based on the total amount of the polymer.

The monomers c) are generally compounds which contain at least two ethylenically unsaturated non-conjugated double bonds in the molecule and thus act as bifunctional crosslinkers in the polymerization. Preferred representatives of monomers c) are, for example, alkylenebis-acrylamides such as methylenebisacrylamide and N,N′-acryloylethylenediamine, N,N′-divinyl-ethyleneurea, N,N′-divinylpropyleneurea, ethylidenebis-3-(N-vinylpyrrolidone), N,N′-divinyl-2,2′-diimidazolylbutane and 1,1′-bis-(3,3′)-vinylbenzimidazolid-2-one)-1,4-butane. Other suitable crosslinkers are, for example, alkylene glycol di(meth)acrylates, such as ethylene glycol diacrylate, ethylene glycol dimethacrylate, tetraethylene glycol diacrylate, tetraethylene glycol dimethacrylate, diethylene glycol diacrylate, diethylene glycol dimethacrylate, aromatic divinyl compounds, such as divinylbenzene and divinyltoluene, and also vinyl acrylate, allyl acrylate, allyl methacrylate, divinyldioxane, pentaerythritol triallyl ether, triallylamines and mixtures of the crosslinkers.

Particularly preferred crosslinkers are ethylene glycol diacrylate, ethylene glycol dimethacrylate, N,N′-divinylethyleneurea (DVEU) and divinylbenzene (DVB).

The crosslinkers are used in amounts of from 0 to 10% by weight, preferably from 0.1 to 8% by weight, particularly preferably in amounts of from 0.2 to 5% by weight, based on the total amount of the polymer.

Monomers d) are generally compounds which are capable of free-radical polymerization. Representatives of these monomers d) are, for example, alkenes or dialkenes, such as ethene, propene, butene, isobutene, methylbutene, methylpentene, isoprene, butadiene, hexadiene, dicyclopentadiene, norbornene, styrene and derivatives thereof. Other monomers are halogenated vinyl monomers, for example vinyl chloride, vinyl fluoride, chloroprene, vinylidene chloride. Monomer derivatives of unsaturated acids, such as acrylic esters, methacrylic esters, such as acrylamides and acrylonitrile are also included. Specific examples of these esters are methyl acrylate, methyl methacrylate, ethyl acrylate, ethyl methacrylate, n-propyl acrylate, n-propyl methacrylate, isopropyl acrylate, isopropyl methacrylate, lauryl acrylate, lauryl methacrylate, stearyl acrylate, stearyl methacrylate and the esters of acrylic acid and methacrylic acid which are derived from the isomeric butanols, such as hydroxyethyl acrylate, hydroxyethyl methacrylate, hydroxymethyl methacrylate, hydroxypropyl acrylate, hydroxypropyl methacrylate, hydroxybutyl acrylate, hydroxybutyl methacrylate. Other suitable monomers are, for example, unsaturated alcohols and amines and derivatives, for example vinyl alcohol, vinyl acetate, vinyl propionate, vinyl stearate, vinyl benzoate, vinyl maleate, vinyl butyral, allyl phthalate, allyl melamine.

Preference is given to popcorn polymers comprising

a) from 50 to 100% by weight of styrene-4-sulfonate and/or a styrene-4-sulfonate-containing derivative,

b) from 0.5 to 30% by weight of at least one N-vinyllactam or N-vinylamine selected from the group consisting of N-vinylpyrrolidone, N-vinylpiperidone, N-vinylcaprolactam, N-vinyl-imidazole and methylated N-vinylimidazole or N-vinylformamide;

c) from 0.1 to 8% by weight of at least one bifunctional crosslinker components selected from the group consisting of N,N′-divinylethyleneurea, N,N′-divinylpropyleneurea or divinylbenzene;

d) from 0 to 30% by weight of styrene, vinylformamide or vinylimidazole.

Particular preference is given to polymers comprising

a) from 75 to 97% by weight of sodium styrene-4-sulfonate

b) from 1 to 25% by weight of N-vinylpyrrolidone;

c) from 0.2 to 5% by weight of N,N′-divinylurea and/or divinylbenzene,

d) from 0 to 30% by weight of styrene.

The polymerization is carried out using known methods, for example as precipitation polymerization, solution polymerization, or by polymerization without solvent.

The invention therefore further relates to a process for preparing insoluble, only slightly swellable, popcorn polymers, which comprises polymerizing in the absence of oxygen

a) from 20 to 100% by weight of styrene-4-sulfonate and/or a styrene-4-sulfonate-containing derivative of the formula I 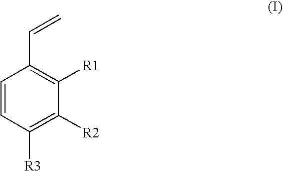
where
R₁, R₂ can be identical or different and are chlorine, bromine, iodine or C₁-C₄-alkyl and
R₃ SO₃⁻— or SO₃H

b) from 0 to 40% by weight of an N-vinyllactam or N-vinylamine,

c) from 0 to 10% by weight of at least one bifunctional crosslinker component

d) from 0 to 80% by weight of further free-radically polymerizable monomers;

the percentages by weight of the individual components totaling 100%.

Preference is given to a procedure in which, as described in EP-A-0177812, the popcorn polymerization is started by heating a mixture of from 99.6% to 98.8% by weight of N-vinyl-pyrrolidone and from 0.4 to 1.2% by weight of a compound as crosslinker which has at least two ethylenically unsaturated double bonds to a temperature of from 100 to 150° C. in the absence of oxygen and polymerization initiators. This polymerization is initiated, in particular, by the presence of small amounts of sodium hydroxide solution or potassium hydroxide solution. Within a short time, a polymerizable popcorn polymer forms which, on the addition of the remaining monomer mixture, that is to say in particular monomer a), the popcorn polymerization of these monomers starts without an induction period. In addition, it is possible to transfer the polymerizable popcorn polymer to an initial charge which contains monomer and crosslinker, or to then add monomer and crosslinker.

The polymerization can also be carried out without solvent. In this case the monomer mixture of a), b) and c) is inertized by introducing nitrogen and then heated to a temperature in the range from 20 to 200° C., preferably from 100 to 200° C., particularly preferably from 150 to 180° C. It is advantageous to pass a gentle nitrogen stream through the monomer mixture during the polymerization also.

The absence of oxygen is achieved by polymerizing the batch at reduced pressure. Depending on the type of monomers used and the temperature selected, the mixture polymerizes in the course of from 1 to 20 hours. For example, in the polymerization of N-vinylamides with 2% of N,N′-divinylethyleneurea at 150° C. with stirring using a powerful stirrer and a pressure of 310 mbar, after 2.5 hours the first polymer particles form, the amount of which slowly increases until after approximately 10 hours of polymerization time the reaction mixture consists of a powder. The popcorn polymer is obtained therefrom in yields of greater than 90% in the form of a powder having a mean particle size of from about 1 μm to 1 mm, preferably from 1 μm to 250 μm.

For preparing the polymers, precipitation polymerization in water is preferred. The concentration of the monomers is expediently chosen in this case so that the reaction mixture can be stirred readily over the course of the entire reaction period. If the concentration of the monomers in water is too high, for example at 95%, the polymer grains are frequently sticky, so that stirring becomes more difficult than in the absence of solvents. To carry out the reaction in the customary stirred tank, monomer concentrations based on the aqueous mixture of from about 5 to 30% by weight are chosen, preferably from 10 to 20% by weight. If more powerful stirrers are available, the monomer concentration of the aqueous solution can also be increased to 50% by weight, possibly even above this.

The absence of oxygen can be best achieved by heating to boiling the mixture to be polymerized and if appropriate additionally employing an inert gas atmosphere, by, for example, passing nitrogen through the reaction mixture. The polymerization temperature can be varied within a broad range, for example from about 20 to 200° C., preferably from 50 to 150° C.

In some cases it can also be advantageous, for the complete removal of dissolved oxygen, to add small amounts from 0.1 to 1% by weight, based on the monomer, of a reducing agent such as sodium sulfite, sodium pyrosulfite, sodium dithionite (Blankit), ascorbic acid or mixtures of the reducing agents.

In a particularly preferred embodiment of the polymerization, the comonomer b), a part of the crosslinker, water and if appropriate a buffer and also a reducing agent are heated in a gentle nitrogen stream until the first polymer particles appear. Then, a mixture, which has been inertized in advance by blowing in nitrogen, of, in particular, sodium styrene-4-sulfonate, if appropriate crosslinker, and if appropriate water and diluent, is added in the course of from 0.2 to 10 hours. The sodium styrene-4-sulfonate and the crosslinker can also be dissolved in a water-miscible solvent. This could be, for example, lower alcohols such as methanol, ethanol, isopropanol, n-propanol or t-butanol. This procedure has the advantage that the popcorn polymerization only requires a relatively short time. The popcorn polymers can be isolated from the aqueous solution and purified.

The popcorn polymers are customarily produced at a yield of from about 90 to >99% of the theoretical yield. They can be isolated from the aqueous suspension by filtering or centrifuging with subsequent washing with water and drying in customary dryers, such as circulation or vacuum dryers, paddle dryers or pneumatic dryers. The popcorn polymers are virtually insoluble in water and all solvents and also swell only slightly therein.

Popcorn polymers of sodium styrene-4-sulfonate can be polymerized in aqueous solution in the absence of oxygen. Adding small amounts of a multifunctional monomer (from 0.1% to 5%) accelerates the reaction and increases the yield up to approximately 95%.

Insoluble highly crosslinked sodium styrene-4-sulfonate-containing polymers are also prepared by solution polymerization.

The name solution polymers means a polymer which has been prepared by homogeneous polymerization in a monomer-miscible solvent. The type of precipitation polymerization is known to the expert.

The inventive polymers thus obtainable give insoluble, highly crosslinked polymer particles which can be used as adsorbents, ion exchangers, support materials, filter aids, dye transfer inhibitors for laundry detergents or additives in cosmetic, dermatological or pharmaceutical formulations. Preferably, the inventive polymers are used as tablet disintegrant or for filtering liquids, in particular beer.

The invention further relates to tablet disintegrants comprising the inventive polymers.

The invention further relates to a process for filtering a liquid using a filter aid comprising

a) from 20 to 100% by weight of styrene-4-sulfonate and/or a styrene-4-sulfonate-containing derivative of the formula (I) 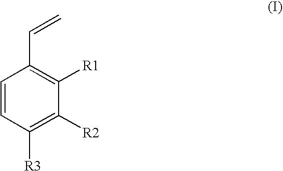
where
R₁, R₂ can be identical or different and are chlorine, bromine, iodine or C₁-C₄-alkyl and
R₃ SO₃⁻— or SO₃H

b) from 0 to 40% by weight of an N-vinyllactam or N-vinylamine,

c) from 0 to 10% by weight of at least one bifunctional crosslinker component

d) from 0 to 80% by weight of further free-radically polymerizable monomers

where the percentages by weight of the individual components a) to d) relate to the total amount of the popcorn polymer and total 100%.

The preferred filtration technique used is the technique of precoat filtration.

The invention likewise relates to a filter aid comprising

a) from 20 to 100% by weight of styrene-4-sulfonate and/or a styrene-4-sulfonate-containing derivative of the formula (I) 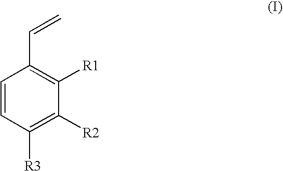
where
R₁, R₂ can be identical or different and are chlorine, bromine, iodine or C₁-C₄-alkyl and
R₃ SO₃⁻— or SO₃H

b) from 0 to 40% by weight of an N-vinyllactam or N-vinylamine,

c) from 0 to 10% by weight of at least one bifunctional crosslinker component

d) from 0 to 80% by weight of further free-radically polymerizable monomers

where the percentages by weight of the individual components a) to d) relate to the total amount of the popcorn polymer and total 100%.

For the purposes of the present invention, filtration is passing a suspension (slurry) consisting of a discontinuous phase (disperse substances) and a continuous phase (dispersion medium) through a porous filter medium. In the process solid particles are deposited on the filter medium and the filtered liquid (filtrate) leaves the filter medium in a clear state. An external force used to overcome the resistance to flow, in this case, is an applied pressure difference.

During the filtration operation, fundamentally different mechanisms of solids deposition can be observed. Principally these are surface or cake filtration, sheet filtration and sieve filtration. Frequently a combination of at least two processes is involved.

In the case of surface or cake filtration, precoat filters are used in various designs for beverage filtration (Kunze, Wolfgang, Technologie Brauer und Mälzer [Brewing and malting technology], 7th edition, 1994, p. 372). All precoat systems have in common the fact that solids present in the liquid to be filtered and also solids added intentionally (filter aid) are retained by a filter medium, a filter cake being built up. In the course of filtration, flow must pass through this and also the filter medium. A filtration process of this type is also termed precoat filtration.

The liquids to be filtered in accordance with the invention are fruit juices or fermented beverages, such as-wine or beer. In particular, preference is given to the inventive process for filtering beer.

The inventively provided filter aids are distinguished by good wettability with water and constant flow rate with simultaneously high filter action.

Production of the inventive polymers will be considered in more detail with reference to the examples hereinafter.

Production of the Polymers

An amount of vinylpyrrolidone which corresponds in each case to the composition to be attained is placed in water, sodium hydroxide solution (5% strength), crosslinker and Blankit (Na₂S₂O₄) and sparged with nitrogen. The nitrogen flow rate during the entire experiment is 12 l/h. The temperature is set at 70° C. After the end of the starting reaction, a feed 1 of sodium styrene-4-sulfonate hydrate dissolved in water and a feed 2 of crosslinker in ethanol are added dropwise over a period of 5 hours and the mixture is then further polymerized for approximately 9 hours.

The examples hereinafter are to verify the invention by way of example.

### EXAMPLES

VP/sodium styrene-sulfonate hydrate/styrene 23:68:(9) (table 1, example 5):

Initial charge: 50.0 g of vinylpyrrolidone; 500.0 g of deionized water, 0.50 g of NaOH (5% strength), 1.00 g of DVEU, 110.0 mg of Blankit

Feed 1: 150.0 g of sodium styrene-4-sulfonate hydrate, 825.0 g of deionized water

Feed 2: 20.0 g of styrene, 4.5 g of DVB

Yield (%): 60.3

VP/sodium styrene-4-sulfonate hydrate 1:3 (table 1, example 6)

Initial charge: 50.0 g of vinylpyrrolidone; 500.0 g of deionized water, 0.50 g of NaOH (5% strength), 1.00 g of DVEU, 110 mg of Blankit

Feed 1: 150.0 g of sodium styrene-4-sulfonate hydrate, 825 g of deionized water

Feed 2: 4.50 g of DVB, 45.0 g of ethanol

Yield (%): 53

VP/sodium styrene-4-sulfonate hydrate 1:0 (table 1, example 9)

Initial charge: 25.0 g of vinylpyrrolidone; 250.0 g of deionized water, 0.25 g-of NaOH (5% strength), 0.5 g of DVEU, 55.0 mg of Blankit

Feed 1: 250.0 g of sodium styrene-4-sulfonate hydrate, 1100.0 9 of deionized water

Feed 2: 7.5 g of DVB, 75.0 g of ethanol

TABLE 1
The reaction temperature was 70° C. in all cases.

| | | | | Bulk | Sieve analysis | |
|---|---|---|---|---|---|---|
| | | | | density | 500 μm// | Swelling |
| | | | Crosslinker | [g/ml] | >250-500 μm// | volume |
| Ex. | Polymer* | Yield [%] | [% by wt.] | <250 μm | <250 μm | in H₂O [%] |
| 1 | 1:1 | 73.8 | DVB*/2.0 | 19.2 | 81.5//10.0//8.5 | 100 |
| 2 | 1:1 | 54.1 | DVEU*/2.5 | 14.2 | 59.2//25.5//15.3 | 101 |
| 3 | 1:2 | 58.1 | DVB/2.7 | 14.7 | 80.0//4.8//15.2 | 106 |
| 4 | 1:3 | 52.5 | DVB/2.8 | 15.4 | 89.0//3.0//8.0 | 113 |
| 5 | 23:68:(9) | 60.3 | DVB/2.5 | 18.2 | 67.4//22.9//9.7 | 104 |
| 6 | 1:3 | 53.0 | DVB/2.8 | 14.0 | 48.8//11.2//40.0 | 90 |
| 7 | 1:4 | 67.7 | DVB/2.8 | 12.7 | 93.8//1.2//5.0 | 75 |
| 8 | 1:5 | 58.5 | DVB/2.8 | 18.9 | 56.0//24.0//20.0 | 109 |
| 9 | 1:10 | 62.4 | DVB/2.9 | 25.8 | 81.0//12.6//6.4 | 176 |
| 10 | 23:68:(9) | 57.2 | DVEU/2.5 | 13.0 | 71.2//4.0//24.8 | 78 |
| 11 | 1:1 | 63.0 | DVB/2.0 | 13.8 | 52.4//29.4//18.2 | 104 |
| 12 | 12:68:(20) | 48.1 | DVB/2.5 | 18.2 | 79.6//12.4//8.0 | 100 |
| C. Ex.* | PVP | 100 | DVEU/2.0 | 21.3 | 76.3//23.5//0.2 | 139 |

Polymer* = VP/sodium styrene-4-sulfonate hydrate/(styrene)
DVEU* = Divinylethyleneurea
DVB* = Divinylbenzene
C. Ex. = Comparative example

Below, experiments using the polymer examples described in table 1 are described. The behavior of the inventive polymers as filter aids and tablet disintegrants was studied.

Weight out from 20 to 100 mg of popcorn (based on dry matter).

Add 200 ml of decarbonated beer

Contact time during stirring exactly 5 minutes

Filter through a glass frit

Take filtrate for tannoid determination.

Method for determining tannoids

Tannometer, from Pfeuffer (haze titration)

The tannoid content of beer is determined using polyvinylpyrrolidone. Proteinaceous compounds add to tannoids via hydrogen bonds. This produces turbidity as a result of complexing. In the Tannometer the turbidity is measured as a function of the amount of PVP added. The result gives the tannoid content in mg of PVP/I of beer.

TABLE 2
Measurement of tannoid content

| Ex. | Tannoids [PVP/mg/l] |
|---|---|
| 5 | 24.9 |
| 6 | 20.5 |
| 9 | 25.6 |
| C. Ex. | 28.1 |

TABLE 3
Measurement of tablet disintegration times

| Ex. | Disintegration time [sec.] | Amount of disintegrant [mg] |
|---|---|---|
| 5 | 30 | |
| 6 | 30 | |
| 9 | 30 | |
| C. Ex. | 30 | 2.0 |

1. A popcorn polymer comprising
a) from 20 to 100% by weight of styrene-4-sulfonate and/or a styrene-4-sulfonate-containing derivative of the formula I 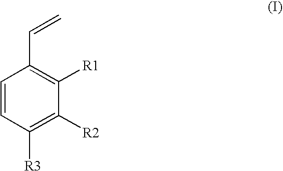
where
R₁, R₂ can be identical or different and are chlorine, bromine, iodine or C₁-C₄-alkyl and
R₃ is SO₃ or SO₃H,
b) from 0 to 40% by weight of an N-vinyllactam or N-vinylamine,
c) from 0 to 10% by weight of at least one bifinctional crosslinker component, and
d) from 0 to 80% by weight of further free-radically polymerizable monomers
where the percentages by weight of the individual components a) to d) relate to the total amount of the popcorn polymer and total 100%.

2. A popcorn polymer as claimed in claim 1 comprising
a) from 50 to 100% by weight of styrene-4-sulfonate and/or a styrene-4-sulfonate-containing derivative;
b) from 0.5 to 30% by weight of at least one N-vinyllactam or N-vinylamine selected from the group consisting of N-vinylpyrrolidone, N-vinylpiperidone, N-vinylcaprolactam, N-vinylimidazole, methylated N-vinylimidazole or N-vinylformamide;
c) from 0.1 to 8% by weight of at least one bifunctional crosslinker component selected from the group consisting of N,N′-divinylethyleneurea, N,N′-divinylpropyleneurea or divinylbenzene; and
d) from 0 to 30% by weight of styrene, vinylformamide or vinylimidazole.

3. A popcorn polymer as claimed in claim 1, comprising
a) from 75 to 97% by weight of sodium styrene-4-sulfonate,
b) from 1 to 25% by weight of N-vinylpyrrolidone,
c) from 0.2 to 5% by weight of N,N′-divinylurea and/or divinylbenzene, and
d) from 0 to 30% by weight of styrene.

4. A process for preparing a popcorn polymer, which comprises polymerizing in the absence of oxygen
a) from 20 to 100% by weight of styrene-4-sulfonate and/or a styrene-4-sulfonate-containing derivative of the formula (I) 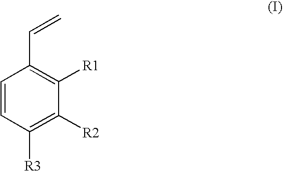
where
R₁, R₂ can be identical or different and are chlorine, bromine, iodine or C₁-C₄-alkyl and
R₃ is SO₃ or SO₃H,
b) from 0 to 40% by weight of an N-vinyllactam or N-vinylamine,
c) from 0 to 10% by weight of at least one bifunctional crosslinker component, and
d) from 0 to 80% by weight of further free-radically polymerizable monomers where the percentages by weight of the individual components total 100%.

5. The use of the popcorn polymer of claim 1 as adsorbents, ion exchangers, support materials, filter aids, dye transfer inhibitors for laundry detergents, additives in cosmetic, dermatological or pharmaceutical formulations or tablet disintegrants.

6. The use of the popcorn polymer of claim 5 as filter aid.

7. The use of the popcorn polymer of claim 5 as tablet disintegrant.

8. A process for filtering a liquid using a filter aid comprising
a) from 20 to 100% by weight of styrene-4-sulfonate and/or a styrene-4-sulfonate-containing derivative of the formula (I) 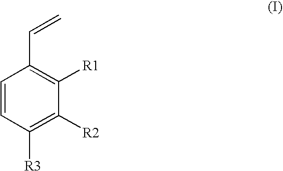
where
R₁, R₂ can be identical or different and are chlorine, bromine, iodine or C₁-C₄-alkyl and R₃ is SO₃ or SO₃H.
b) from 0 to 40% by weight of an N-vinyllactam or N-vinylamine,
c) from 0 to 10% by weight of at least one bifunctional crosslinker component, and
d) from 0 to 80% by weight of further free-radically polymerizable monomers
where the percentages by weight of the individual components a) to d) relate to the total amount of the popcorn polymer and total 100%.

9. A filter aid comprising a popcorn polymer as claimed in claim 1.

10. A tablet disintegrant comprising a popcorn polymer as claimed in claim 1.

11. A popcorn polymer consisting essentially of:
a) from 75 to 97% by weight of styrene-4-sulfonate and/or a styrene-4-sulfonate-containing derivative of the formula I 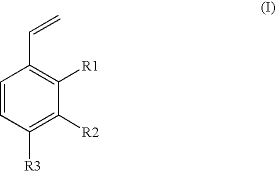
where
R₁, R₂ can be identical or different and are chlorine, bromine, iodine or C₁-C₄-alkyl and
R₃ is SO₃ or SO₃H;
a) from 1 to 25% by weight of N-vinylpyrrolidone;
b) from 0.2 to 5% by weight of N,N′-divinylurea and/or divinylbenzene; and
c) from 0 to 30% by weight of styrene.

12. The use of the popcorn polymer of claim 11 as a filter aid or as a tablet disintegrant.

13. A filter aid comprising a popcorn polymer as claimed in claim 3.
